(19) United States
(12) Patent Application Publication
(10) Pub. No.: US 2017/0098887 A1
(43) Pub. Date: Apr. 6, 2017

(54) Antenna Module Having Holder Formed with Hollow

(71) Applicant: Wistron NeWeb Corporation, Hsinchu (TW)

(72) Inventor: Yung-Jinn Chen, Hsinchu (TW)

(21) Appl. No.: 14/874,480

(22) Filed: Oct. 5, 2015

(51) Int. Cl. H01Q 1/24; H01Q 9/04; H01Q 5/10; H04B 1/3827

(52) U.S. Cl. CPC H01Q 1/245; H04B 1/3838; H01Q 9/04; H01Q 5/10

(57) ABSTRACT

An antenna module for a wireless communication device includes an antenna including a first arm for resonating wireless signals in a high frequency band and a second arm for resonating wireless signals in a low frequency band, and a holder formed with at least one hollow, wherein the at least one hollow is adjacent to a first surface of the holder, a second surface of the holder and a third surface of the holder, the first surface is adjacent to the second surface, and the second surface is adjacent to the third surface.

### BACKGROUND OF THE INVENTION

1. Field of the Invention

The present invention relates to an antenna module for a wireless communication device, and more particularly, to an antenna module having a holder formed with a hollow.

2. Description of the Prior Art

A wireless communication device, such as a mobile phone, a tablet computer, a laptop computer and so on, exchanges radio-frequency signals through an antenna to access information within a wireless communication system. A radio-frequency (RF) signal is a sinusoidal wave with a high oscillating frequency, and governments in the world have defined safety limits, e.g. by electromagnetic standards, for exposure to RF energy produced from wireless communication devices, which mainly exposes to human head or limb. The electromagnetic standards as to the RF energy exposure are based on SAR (specific absorption rate) instead of on the ration of maximum/minimum output power. SAR is a measure of the rate at which energy is absorbed by a human body when exposed to an RF electromagnetic field. According to ICNIRP (International Commission on Non-Ionizing Radiation Protection), a recommended SAR value should not exceed 2.0 W/Kg. According to FCC (Federal Communications Commission), the recommended SAR value should not exceed 1.6 W/Kg.

Due to a trend of light and compact wireless communication device and growing wireless communication demands, an ideal antenna inside the wireless communication device should be small, antenna gain thereof should be high and radiating bandwidth thereof should be as wider as possible. However, as well known in the art, the greater antenna gain, the worse SAR value. Also, RF energy with high frequencies is easily to be absorbed in near field, which leads to the worse SAR value.

Therefore, how to solve the tradeoff between SAR and antenna performance has become a goal in the wireless communication industry.

### SUMMARY OF THE INVENTION

It is therefore an objective of the present invention to provide an antenna module for a wireless communication device having a holder formed with a hollow.

An embodiment of the present invention discloses an antenna module for a wireless communication device includes an antenna including a first arm for resonating wireless signals in a high frequency band and a second arm for resonating wireless signals in a low frequency band, and a holder formed with at least one hollow, wherein the at least one hollow is adjacent to a first surface of the holder, a second surface of the holder and a third surface of the holder, the first surface is adjacent to the second surface, the second surface is adjacent to the third surface, the first arm is formed on the first surface, the second arm is formed on a fourth surface, the first surface is perpendicular to the second surface, the first surface is parallel to the fourth surface to be separated by a distance along a first direction, the first direction is perpendicular to the first surface, and the first surface and the fourth surface are formed in different levels along the first direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an antenna module.

FIG. 2 illustrates an antenna module according to an embodiment of the present invention.

FIG. 3 illustrates an antenna module according to another embodiment of the present invention.

FIG. 4 illustrates an antenna module according to another embodiment of the present invention.

FIG. 5 illustrates an antenna module according to another embodiment of the present invention.

FIG. 6 illustrates an antenna module according to another embodiment of the present invention.

### DETAILED DESCRIPTION

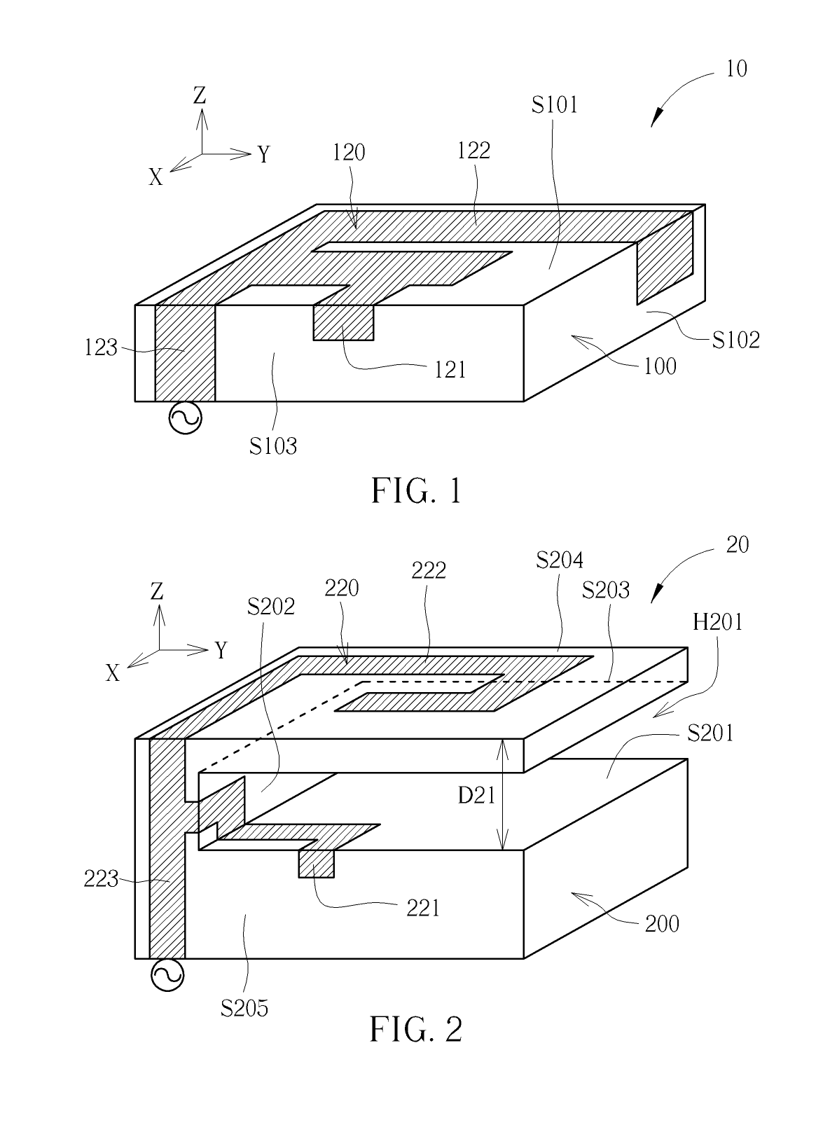

Concerning aesthetics, endurance and operating performance, the wireless communication device is usually built-in with an antenna module. FIG. 1 illustrates an antenna module 10. The antenna module 10 may be placed in a housing (not shown in FIG. 1) of a wireless communication device for resonating wireless signals to achieve wireless communication. The antenna module 10 includes a holder 100 and an antenna 120. The antenna 120 includes arms 121, 122 and 123.

The holder 100 may be a cuboid for holding and supporting the antenna 120 to protect the antenna 120 from deformation, wherein the antenna 120 maybe formed on one or more of six surfaces of the holder 100. For example, the arms 121, 122 and 123 maybe formed on surfaces S101, S102 and S103 of the holder 100. The arm 121 together with the arm 123 may be used for resonating RF signals with high frequency, and the arm 122 together with the arm 123 may be used for resonating RF signals with low frequency.

Note that the arms 121 and 122 are formed on the same surface S101 (X-Y plane), which causes the worse SAR value since RF energy within the near field of the arm 121 is relatively intensive. Further, isolations between the arms 121 and 122 may be bad since they are close to each other (e.g., harmonics for wireless signals resonated by the arm 122 may interfere the arm 121).

From another point of view, the cuboid holder 100 may limit a flexibility in designing the antenna pattern of the antenna 120. For example, there are at most six surfaces that the arms 121 and 122 can be formed on the holder 100.

An embodiment of the present invention provides a holder formed with a hollow to form additional surfaces on the holder. Specifically, FIG. 2 illustrates an antenna module 20 according to an embodiment of the present invention. The antenna module 20 includes a holder 200 and an antenna 220, which may be made of metals or flexible printed circuit (FPC), or formed by laser direct structuring (LDS) to adhere to the holder 200.

The antenna 220 includes arms 221, 222 and 223, and a feed terminal. The antenna 220 may operate in multiple frequency bands. For example, the arm 221 together with the arm 223 may be used for resonating wireless signals in a high frequency band, and the arm 222 together with the arm 223 may be used for resonating wireless signals in a low frequency band.

The holder 200 may be formed with a hollow H201 and surfaces S201-S205, and the holder 200 may be a cuboid for holding and supporting the antenna 220 to protect the antenna 220 from deformation. The arm 221 may be formed on the surfaces S201, S202 and S205, the arm 222 may be formed on the surface S204, and the arm 223 may be formed on the surface S205.

Noticeably, compared with the holder 100 shown in FIG. 1, the surfaces S201-S203 of the holder 200 are formed because of the hollow H201. In structure, the hollow H201 may be adjacent to the surfaces S201-S203, the surface S201 may be adjacent to the surface S202, and the surface S202 may be adjacent to the surface S203. The surface S201 may be perpendicular to the surface S202, the surface S201 may be parallel to the surface S204 to be separated by a distance D21 along a Z-direction, the Z-direction is perpendicular to the surface S201, and the surfaces S201 and S204 may be formed in different levels along the Z-direction. The surface S203 may be located between the surfaces S201 and S204, and the surface S203 is parallel to the surfaces S201 and S204. Projections of the surface S201, S203 and S204 along the Z-direction may be overlapped.

In such a structure, the arm 221 and 222 may be formed on different surfaces, which increases the flexibility in designing the antenna pattern. For example, the arm 222 may be extended to the surface S203 for resonating wireless signals in a lower frequency band.

Moreover, the surface S204 may be placed adjacent to a housing of the wireless communication device to keep the arm 221 away from the housing at least by the distance D21 which is greater than 1/20 wavelength of a high frequency band of the antenna 220. Therefore, when performing the SAR test for the high frequency band, RF energy out of the near field of the arm 221 degrades rapidly so an acceptable SAR value may be obtained. Further, isolations between the arms 221 and 222 may be improved by forming the hollow H201.

In short, the embodiment of the present invention provides the holder formed with the hollow to form additional surfaces on which arms of the antenna can be formed to increase the flexibility for designing antenna pattern. In addition, the holder may separate the arm for the high frequency band from the arm for the low frequency band and the housing of the wireless communication device to obtain the acceptable SAR value when performing the SAR test for the high frequency band. Further, isolations between the arms may be improved by forming the hollow. Those skilled in the art may make modifications or alterations accordingly without limitations.

For example, multiple hollows may be formed on the holder, thereby the more surfaces on which the antenna traces can be formed may be obtained. Locations where the hollow is formed and a shape of the hollow may be arbitrary to adapt to the housing of the wireless communication device. The distance D21 between the surfaces S201 and S204 may be adjusted according to practical requirements. A pillar may be placed in the hollow to protect the holder from deformation (e.g., external forces due to assembly process or dropping).

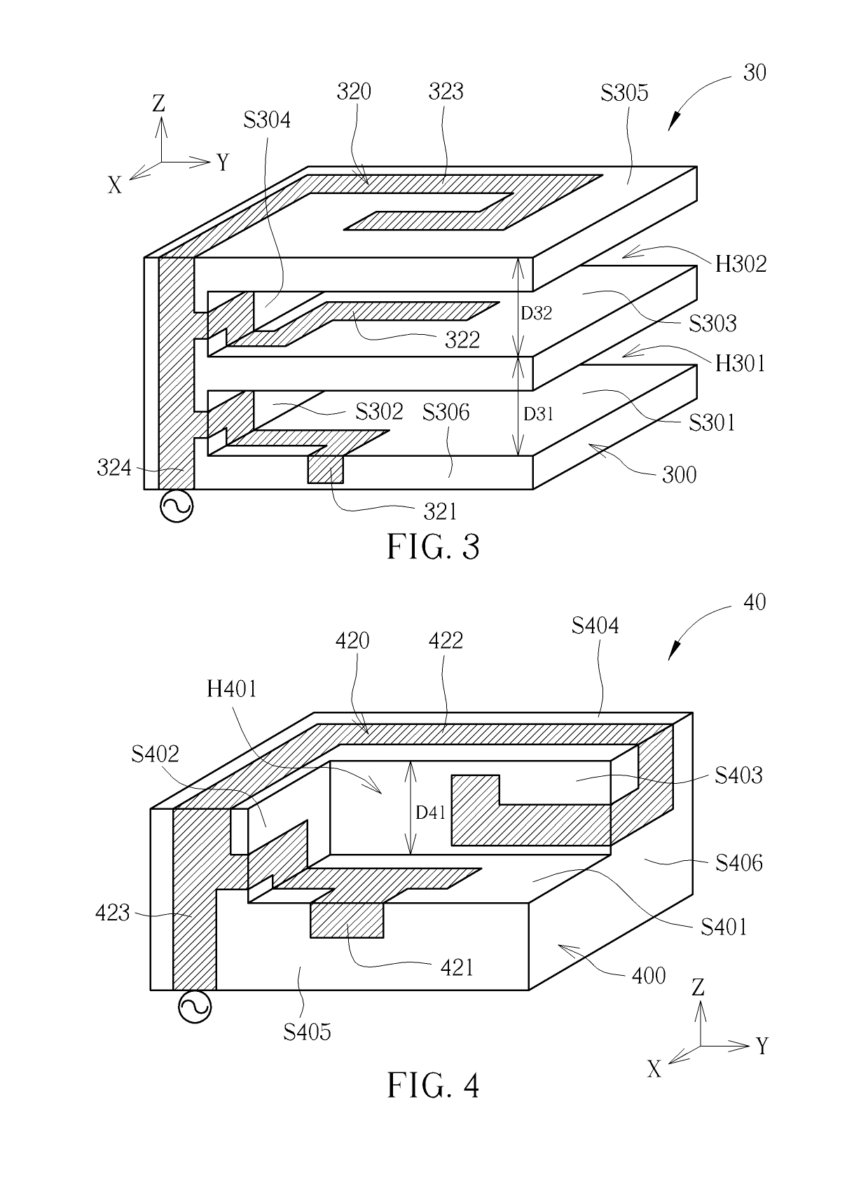

FIG. 3 illustrates an antenna module 30 according to another embodiment of the present invention. The antenna module 30 includes a holder 300 and an antenna 320. As shown in FIG. 3, two hollows H301 and H302 may be formed in the holder 300, and surfaces S301-S306 may be formed on the holder 300.

The antenna 320 includes arms 321, 322, 323 and 324, and a feed terminal. The antenna 320 may operate in multiple frequency bands. Specifically, the arm 321 together with the arm 324 may be used for resonating wireless signals in a first frequency band, the arm 322 together with the arm 324 maybe used for resonating wireless signals in a second frequency band, and the arm 323 together with the arm 324 may be used for resonating wireless signals in a third frequency band. The first frequency band may be higher than the second and third frequency bands, and the second frequency band may be higher than the third frequency band. In another embodiment, the first and second frequency bands may be the same.

The arm 321 maybe formed on the surfaces S301, S302 and S306, the arm 322 may be formed on the surfaces S303 and S304, the arm 323 may be formed on the surface S305, and the arm 324 may be formed on the surface S306.

Noticeably, compared with the holder 200 shown in FIG. 2, the surfaces S301-S304 are additionally formed because of the hollows H301 and H302. Therefore, by increasing the number of the hollows, additional arms of the antenna may be formed, which increases the flexibility for designing the antenna pattern and broadens a bandwidth of the antenna.

Moreover, the surface S305 maybe placed adjacent to a housing of the wireless communication device, the arm 322 may be separated from the arm 321 by a distance D31 between the surfaces S301 and S303, and the arm 323 may be separated from the arm 322 by a distance D32 between the surfaces S303 and S305 to keep the arm 322 away from the housing. The arm 321 may be separated from the arm 323 by a sum of the distances D31 and D32 to keep the arm 321 away from the housing. The surface S301 may be parallel to the surfaces S303 and S305 to be formed indifferent levels along the Z-direction. The surface S303 may be located between the surfaces S301 and S305. Projections of the surface S301, S303 and S305 along the Z-direction may be overlapped.

Therefore, when performing the SAR test for the high frequency band, RF energy out of the near field of the arm 321 or 322 degrades rapidly so an acceptable SAR value may be obtained. Further, isolations between the arms 321, 322 and 323 may be improved by forming the hollows H301 and H302.

FIG. 4 illustrates an antenna module 40 according to another embodiment of the present invention. The antenna module 40 includes a holder 400 and an antenna 420. As shown in FIG. 4, a hollow H401 maybe formed in the holder 400, and surfaces S401-S406 maybe formed on the holder 400.

The antenna 420 includes arms 421, 422 and 423, and a feed terminal. The antenna 420 may operate in multiple frequency bands. Specifically, the arm 421 together with the arm 423 may be used for resonating wireless signals in a high frequency band, and the arm 422 together with the arm 423 may be used for resonating wireless signals in a low frequency band.

The arm 421 maybe formed on the surfaces S401, S402 and S405, the arm 422 may be formed on the surfaces S403, S404 and S406, and the arm 423 may be formed on the surface S405. The hollow H401 may be adjacent to the surfaces S401-S403, the surface S401 maybe adjacent to the surfaces S402, S403, S405 and S406, and the surface S402 may be adjacent to the surfaces S401 and S403-S405. The surface S401 may be parallel to the surface S404 to be separated by a distance D41 between the surfaces S401 and S404 along the Z-direction. The surface S401 is perpendicular to the surfaces S402 and S403. Projections of the surfaces S401 and S404 along the Z-direction (or parallel to the X-Y plane) may not be overlapped.

The surface S404 may be placed adjacent to a housing of the wireless communication device, and the hollow H401 may separate the arm 422 from the arm 421 by the distance D41 to keep the arm 421 away from the housing. Therefore, when performing the SAR test for the high frequency band, RF energy out of the near field of the arm 421 degrades rapidly so an acceptable SAR value maybe obtained. Further, isolations between the arms 421 and 422 may be improved by forming the hollow H401.

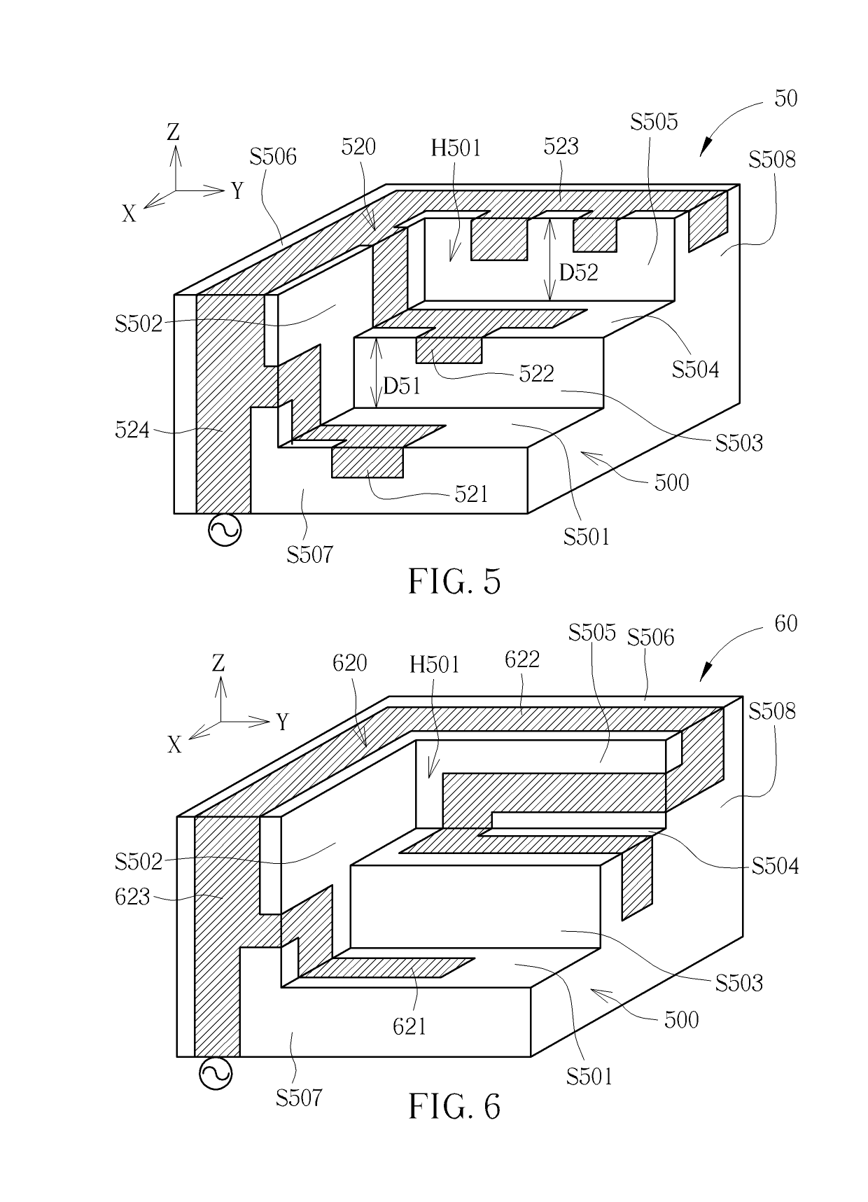

FIG. 5 illustrates an antenna module 50 according to another embodiment of the present invention. The antenna module 50 includes a holder 500 and an antenna 520. As shown in FIG. 5, a hollow H501 maybe formed in the holder 500, and surfaces S501-S508 maybe formed on the holder 500. A difference between the antenna modules 40 and 50 lies in their shapes, wherein the holder 500 has a ladder shape.

The antenna 520 includes arms 521, 522, 523 and 524, and a feed terminal. The antenna 520 may operate in multiple frequency bands. Specifically, the arm 521 together with the arm 524 may be used for resonating wireless signals in a first frequency band, the arm 522 together with the arm 524 maybe used for resonating wireless signals in a second frequency band, and the arm 523 together with the arm 524 may be used for resonating wireless signals in a third frequency band. The first frequency band may be higher than the second and third frequency bands, and the second frequency band may be higher than the third frequency band. In another embodiment, the first and second frequency bands may be the same.

The arm 521 may be formed on the surfaces S501, S502 and S507, the arm 522 may be formed on surfaces S502-S504, the arm 523 may be formed on surfaces S505, S506 and S508 of the holder 500, and the arm 524 may be formed on the surface S507 of the holder 500. The hollow H501 may be adjacent to the surfaces S501-S505, the surface S501 may be adjacent to the surfaces S502, S503, S507 and S508, and the surface S502 may be adjacent to the surfaces S501-S507. The surface S501 may be parallel to the surfaces S504 to be separated by a distance D51 between the surfaces S501 and S504 along the Z-direction. The surface S504 may be parallel to the surfaces S506 to be separated by a distance D52 between the surfaces S504 and S506 along the Z-direction. The surface S501 is perpendicular to the surfaces S502, S503, S505, S507 and S508. Projections of the surfaces S501, S504 and 506 along the Z-direction (or parallel to the X-Y plane) may not be overlapped.

The surface S506 may be placed adjacent to a housing of the wireless communication device, and the hollow H501 may separate the arm 521, 522 and 523 from each other to keep the arms 522 and 521 away from the housing. Therefore, when performing the SAR test for the high frequency band, RF energy out of the near field of the arms 522 and 521 degrades rapidly so an acceptable SAR value may be obtained. Further, isolations between the arms 521, 522 and 523 may be improved by forming the hollow H501.

FIG. 6 illustrates an antenna module 60 according to another embodiment of the present invention. The antenna module 60 includes the holder 500 and an antenna 620. A difference between the antenna modules 50 and 60 lies in patterns of the antenna 520 and 620.

The antenna 620 includes arms 621, 622 and 623, and a feed terminal. The antenna 620 may operate in multiple frequency bands. Specifically, the arm 621 together with the arm 623 may be used for resonating wireless signals in a high frequency band, and the arm 622 together with the arm 623 may be used for resonating wireless signals in a low frequency band.

The arm 622 maybe formed on surfaces S504, S505, S506 and S508 to have a longer current route compared with a current route of the arm 522, the arm 621 may be formed on surfaces S501 and S502, and the arm 623 may be formed on surface S507.

In such a structure, different antenna patterns of the antennas 520 and 620 may be formed on the same holder 500, which increases the flexibility for designing antenna pattern.

To sum up, the various embodiments of the present invention provide the holder formed with the hollow to form additional surfaces on which arms of the antenna can be formed to increase the flexibility for designing antenna pattern. In addition, the holder may separate the arm for the high frequency band from the arm for the low frequency band and the housing of the wireless communication device to obtain the acceptable SAR value when performing the SAR test for the high frequency band. Further, isolations between the arms of the antenna may be improved by forming the hollow.

Those skilled in the art will readily observe that numerous modifications and alterations of the device and method may be made while retaining the teachings of the invention. Accordingly, the above disclosure should be construed as limited only by the metes and bounds of the appended claims.

1. An antenna module for a wireless communication device, comprising:
an antenna comprising a first arm for resonating wireless signals in a high frequency band, and a second arm for resonating wireless signals in a low frequency band; and
a holder formed with at least one hollow,
wherein the at least one hollow is adjacent to a first surface of the holder, a second surface of the holder and a third surface of the holder, the first surface is adjacent to the second surface, and the second surface is adjacent to the third surface;
wherein the first arm is formed on the first surface, the second arm is formed on a fourth surface, the first surface is perpendicular to the second surface, the first surface is parallel to the fourth surface to be separated by a distance along a first direction, and the first direction is perpendicular to the first surface;
wherein the distance is greater than 1/20 wavelength of the wireless signals in the high frequency band.

2. The antenna module of claim 1, wherein the at least one hollow forms a cuboid shape, the third surface is located between the first and fourth surfaces, the third surface is parallel to the first and fourth surfaces, and a length of the at least one hollow is smaller than a length of the holder.

3. The antenna module of claim 2, wherein projections of the first and fourth surfaces along the first direction are overlapped.

4. The antenna module of claim 1, wherein the first surface is adjacent to the third surface, and the first surface is perpendicular to the third surface.

5. The antenna module of claim 1, wherein the at least one hollow forms a ladder shape, the at least one hollow is adjacent to a fifth surface of the holder and a sixth surface of the holder, the fifth surface is adjacent to the first, second and sixth surfaces, and the sixth surface is adjacent to the second surface.

6. The antenna module of claim 5, wherein projections of the first, fourth and sixth surfaces along the first direction are not overlapped.

7. The antenna module of claim 1, wherein the fourth surface is placed adjacent to a housing of the wireless communication device to keep the first arm away from the housing by the distance.

8. (canceled)
